(19) United States
(12) Patent Application Publication
(10) Pub. No.: US 2012/0121492 A1
(43) Pub. Date: May 17, 2012

(54) SYSTEM AND METHOD FOR TREATING GAS FROM A BIOMASS GASIFICATION

(75) Inventors: Martin Schaub, Kollbrunn (CH); Daniel Ulrich, Winterthur (CH); Andreas BENEDIKT Meyer, Winterthur (CH)

(73) Assignee: CTU CLEAN TECHNOLOGY UNIVERSE AG, WINTERTHUR (CH)

(21) Appl. No.: 13/380,592

(22) PCT Filed: Jun. 18, 2010
(86) PCT No.: PCT/EP10/58621

§ 371 Date: Jan. 20, 2012

(30) Foreign Application Priority Data
Jun. 24, 2009 (EP) 09 163 560.7

(51) Int. Cl. C01B 3/00; B01J 19/00

(52) U.S. Cl. 423/242.1; 423/210; 422/187

(57) ABSTRACT

A process and a system treat a synthesis gas originating from a biomass gasification, which contains the following steps: a) performing a first quenching of the synthesis gas at a first temperature and a first pressure; b) performing a second quenching of the quenched synthesis gas at a second temperature and a second pressure, wherein the second temperature is lower than the first temperature; c) scrubbing the twice-quenched synthesis gas in an oil scrubber at a scrubbing temperature which is in the range of the second temperature; d) purifying the quenched and scrubbed synthesis gas in a catalyst-doped adsorption stage; and e) feeding the thus-purified synthesis gas into a refining process. The thus-described multistage prepurification by quenching and also an absorption/desorption stage and if appropriate reactive adsorption and also if appropriate HDS catalysis and/or chemisorption fulfils this object in an excellent manner.

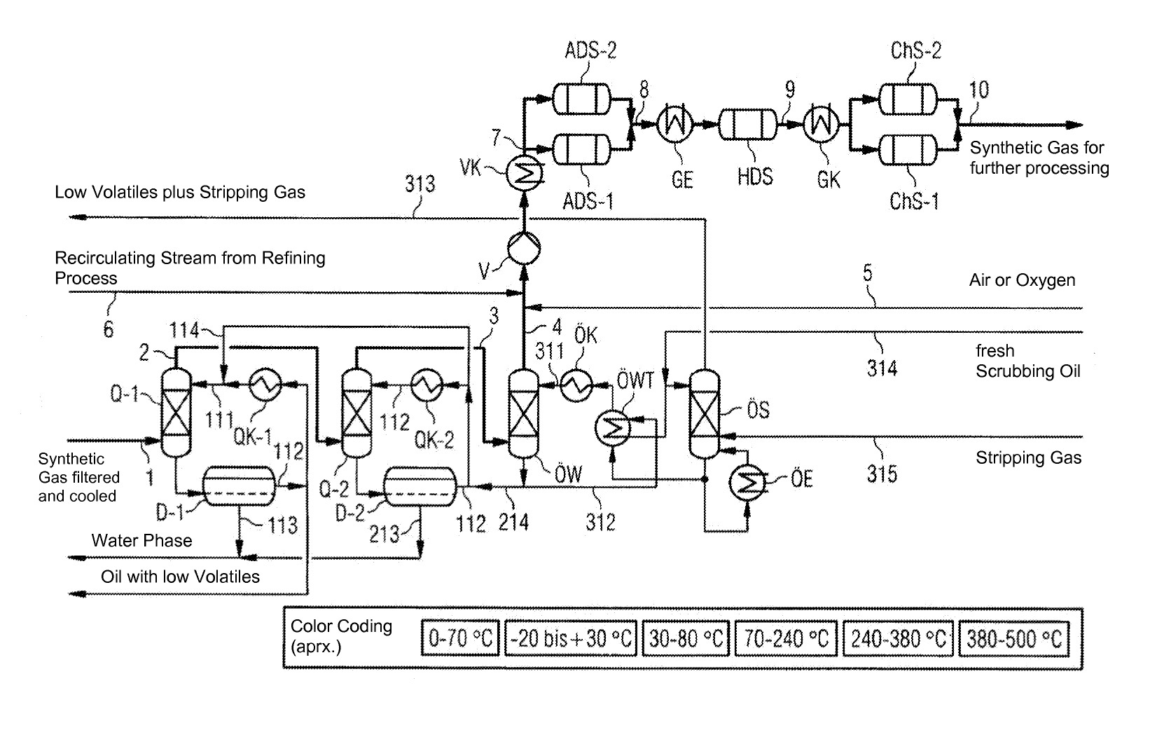

The present invention relates to a system and method for treating gas from a biomass gasification.

Gasifying biomass, especially wood, results in the production of a synthesis gas which in untreated form is unsuitable for most refining processes (for example methanizing, Fischer-Tropsch reaction) because pollutants will still be contained therein in too great a quantity. Pollutants are in particular higher hydrocarbons (very low and low volatiles, particularly aromatic compounds, waxes, and tars) as well as sulfur compounds (for example H₂S, COS, thiols, and sulfur-containing heteroaromatic compounds). If the pollutants can be efficiently removed from the synthesis gas it can be used even for catalytis refining processes (for example methanizing, Fischer-Tropsch reaction).

The object of the present invention is therefore to disclose a method and system for treating gas from a biomass-gasification process that will make the gas available with a purity sufficient for the requisite standing times in the refining process by means of, for instance, a catalyst.

Said object is inventively achieved in terms of the method by means of a method for treating a synthesis gas originating from a biomass-gasification process, which method comprises the following steps:
a) single- or multi-stage cooling and/or quenching of the synthesis gas to a first temperature and first pressure to induce partial condensing for separating out very low volatiles;
b) scrubbing the cooled/quenched synthesis gas in an oil scrubber at a scrubbing temperature within the range of the first temperature, with the loaded scrubbing oil taken from the oil scrubber being thermally regenerated in a stripping column and/or by means of stripping gas and then recycled into the oil scrubber in the cooled state;
c) possibly purifying the cooled/quenched and scrubbed synthesis gas in a catalyst-doped adsorber stage; and
d) feeding the thus purified synthesis gas into a refining process.

Said object is inventively achieved in terms of the system by means of a system for treating a synthesis gas originating from a biomass-gasification process, which system substantially comprises the following components:
a) a first cooler stage or quencher stage that takes the synthesis gas to a first temperature and a first pressure; possibly a subsequent second cooler stage or quencher stage that takes the pre-cooled synthesis gas to a second temperature and second pressure, with the second temperature being lower than the first temperature;
b) a downstream oil scrubber for scrubbing the twice-quenched or, as the case may be, cooled synthesis gas at a scrubbing temperature within the range of the second temperature, with the loaded scrubbing oil taken from the oil scrubber being thermally regenerated in a stripping column and/or by means of stripping gas and then recycled into the oil scrubber in the cooled state;
c) possibly an adsorber stage, downstream of the oil scrubber, for purifying the quenched and scrubbed synthesis gas using a catalyst-/activator-doped adsorbens (doped activated carbon, for instance), in particular for partially oxidizing H₂S; and
e) a feeder for feeding the thus purified synthesis gas into a refining process.

The thus described multi-stage prepurifying by means of at least one cooling/quenching operation and also an absorption/desorption stage and possibly reactive adsorption as well as possibly HDS catalysis (hydrogen-desulfurization catalysis) and/or chemisorption achieves said object excellently. It is therein not absolutely essential to the invention for there to be two cooling/quenching stages. Adequate purifying of the exhaust gas could be achieved also through a single cooling/quenching operation and the subsequent absorption/desorption stage. The temperature of a single cooling/quenching stage should in that case be at the level of the absorption stage (oil scrubber).

With multi-stage quenching it is particularly advantageous for the first temperature to be within a range of 0 to 70° C. and the second temperature to be within a range of −20 to +30° C. Advantageous scrubber temperatures are within the range of the second temperature.

Waste products originating from the refining process such as, for example, a CO₂-rich gas mixture, can be expediently further utilized if the stripping gas originates from the refining process, preferably as a CO₂-rich gas from CO₂ separating.

Particularly good separating will be made possible if some scrubbing oil is removed from the oil-scrubbing process and fresh scrubbing oil added. That will allow very low volatiles that cannot be driven off during desorption to be flushed out of the scrubbing cycle.

If extremely low pollutant values have to be achieved for the treated synthesis gas, it will be particularly advantageous if the thus purified synthesis gas is fed, before being fed to the refining process, to an HDS stage while being heated and then to a chemisorber while being cooled. The sulfur compounds that are still present even after the adsorber stage and are as a rule more organic in nature can in that way be broken away from the synthesis gas and bound in the chemisorber together with H₂S residues.

A gas-purifying cascade of such kind is typically operated permanently and maintenance and/or regeneration functions kept to a minimum. It is for that reason particularly expedient to embody the adsorber stage and/or chemisorber in each case redundantly. One stage will in that way always be linked into the current process while for example the adsorbens or chemisorber can be changed in the respective other stage.

It is furthermore particularly favorable from the efficiency viewpoint if a part of the scrubbing oil that has been removed from the oil scrubber and is loaded with very low volatiles is fed to the first and/or second quenching operation (if existent).

Preferred exemplary embodiments of the present invention are described in more detail with the aid of a figure. Said figure is a schematic of the essential process groups for treating a synthesis gas originating from the biomass-gasification process. The synthesis gas from the biomass-gasification process us usually cooled to around 50 to 150° C. using thermal energy and filtered (1). Said gas is fed to a first cooler/quencher (Q-1). Very low volatiles (tars, waxes, and in part tar oils) as well as water are partially separated from the gas stream at said stage and cooling to around cooling-water temperature takes place at the same time. Separating of the organic phase (112) and watery phase (113) takes place in a decanter (D-1) and thermal energy is removed in a quencher cooler (QK-1). That stage belongs to the prior art, with fresh scrubbing oil repeatedly being added in the quencher (Q-1). The aim is to be able to remove as much energy as possible in a usable manner or by means of cooling water. Already used, preloaded scrubbing oil from a second quencher stage is therein fed subsequently into the first quencher stage (114). It is irrelevant whether said first stage is embodied as a quencher having a cooling circuit and separator/decanter or as a cooler having a separator.

The partially purified gas stream (2) is fed to a second quencher (Q-2). Cooling takes place roughly to the temperature of the oil-scrubbing process (−20 to +30° C.) in this second quenching stage so that the gas can then be further purified. It can thereby be ensured that the liquid from the oil-scrubbing process can be loaded to the maximum extent. Very low volatiles and in part low volatiles (for example aromatic compounds, heavy thiols, sulfur-containing heteroaromatic compounds) as well as water continue being separated from the gas stream at that second quencher stage. The purified gas stream (3) is fed to an oil scrubber (ÖW). Separating of the organic (212) and watery (213) phase takes place in another decanter (D-2) and thermal energy is removed in a quencher cooler (QK-2). Scrubbing oil is taken from the oil-scrubbing process (214). It is irrelevant whether said second stage is embodied as a quencher having a cooling circuit and separator/decanter or as a cooler having a separator.

Achieving a suitably low temperature for absorbing the pollutants in the oil-scrubbing process is essential to the invention. Factors relating to energy and separating technology can make it advantageous to distinguish a first and second cooler/quencher stage.

The oil-scrubbing process after the second quencher stage serves to allow any absorbable pollutants (low volatiles, in particular aromatic compounds, waxes, and tars, as well as thiols and sulfur-containing heteroaromatic compounds) that are still present to be removed from the gas stream (3) to a maximum extent. An oil-like liquid (for example a suitable mineral-oil fraction, a mineral-oil derivative, or a biodiesel such as rapeseed-oil methyl ester) having a high boiling point is for that purpose used for scrubbing in the oil scrubber (ÖW) and the pollutants absorbed in the liquid phase.

The loaded scrubbing oil is thermally regenerated in a stripping column (ÖS) by means of oil heaters/evaporators (ÖE) and/or by means of stripping gas. The stripping gas (315) can originate particularly from a process stage downstream of the refining stage (for example CO₂-rich gas from CO₂ separating). The regenerated scrubbing oil on the oil scrubber (311) is cooled, coming from the oil stripper, via oil heat exchangers (ÖWT), where heat is transferred to the loaded scrubbing oil (312), and oil coolers (ÖK). The oil scrubber is operated preferably at a temperature of −20 to +30° C. Some fresh scrubbing oil will need to be added (314). The combination of absorption (oil scrubber) and desorption (oil stripper) is therein one of the central points for this application, particularly also in combination with reactive adsorption.

A recirculation stream (for example non-reacted gases such as H₂) is often added (6) from the refining process following the treatment process, with such adding expediently able to take place at several locations.

The pressure increase that is customary for method-related processes can take place at several locations within the process, particularly after oil scrubbing or, as the case may be, before reactive adsorption. A system of such kind is usually suitable for a pressure around atmospheric to above 70 bar.

The gas (7) that has been largely freed from absorbable pollutants is ducted via a catalyst-/activator-doped adsorbens (ADS-1 or ADS-2; one fixed bed is in operation, the other is being replaced or is ready for operation or is connected in series downstream). H₂S (and in part also COS) is oxidized onto said specifically doped adsorbens, with elementary sulfur being formed that will be bound to the adsorbens. Unless present in any event owing to leaks in the gas stream, the oxygen required for that will be actively added (5). Residues of very low and low volatiles still to be found in the gas stream (7) will likewise be retained by the adsorbens. That manner of converting H₂S into elementary sulfur and the binding thereof to an adsorbens (particularly by means of doped activated carbon) is based on known technology.

If extremely low pollutant values have to be achieved in the gas, the gas (8) can be fed to an HDS stage (hydrogen-desulfurization catalysis) after being heated (gas heater, GE) so that organic sulfur compounds are broken down and bound, after cooling (gas cooler, GK), in the chemisorber that follows (ChS-1 or ChS-2; one fixed bed is in operation, the other is being replaced or is ready for operation or is connected in series downstream; fixed bed consisting of, for example, metal oxide). Viewed individually, those stages belong in themselves to the prior art, but linking them to the preceding stages is unknown in the prior art.

The purified gas (10) is then fed to a catalytic refining process.

1-14. (canceled)

15. A method for treating a synthesis gas from a biomass-gasification process, which comprises the steps of:
performing one of a single-stage cooling/quenching or a multi-stage cooling/quenching of the synthesis gas at a first temperature and a first pressure resulting in a cooled/quenched synthesis gas;
subsequently performing a second quenching of the cooled/quenched synthesis gas at a second temperature and a second pressure, with the second temperature being lower than the first temperature, the second temperature being suitable for a following scrubbing stage with simultaneous separating of very low volatiles;
scrubbing the cooled/quenched synthesis gas in an oil scrubber at a scrubbing temperature that is within a range of a preceding stage's exiting temperature resulting in a quenched and scrubbed synthesis gas, with a loaded scrubbing oil being taken from the oil scrubber being thermally regenerated in at least one of a stripping column or by means of stripping gas and then recycled into the oil scrubber in a cooled state;
purifying the quenched and scrubbed synthesis gas in a catalyst-doped adsorber stage resulting in purified synthesis gas; and
feeding the purified synthesis gas into a refining process.

16. The method according to claim 15, which further comprises setting the scrubber temperature to be within a range of −20 to +30° C.

17. The method according to claim 15, wherein the stripping gas originates from a refining process.

18. The method according to claim 15, which further comprises adding fresh scrubbing oil to the loaded scrubbing oil removed from an oil-scrubbing process before the scrubbing oil removed enters an oil stripper.

19. The method according to claim 15, wherein the purified synthesis gas is fed, before being fed to a refining process, to a hydrogen-desulfurization catalysis (HDS) stage while being heated and then to a chemisorber while being cooled.

20. The method according to claim 19, wherein at least one of the adsorber stage or the chemisorber is embodied as being redundant.

21. The method according to claim 15, which further comprises feeding a part of the scrubbing oil that has been removed from the oil scrubber to at least one of a first or second quenching operation.

22. The method according to claim 17, wherein the stripping gas is a CO₂-rich gas from CO₂ separating.

23. A system for treating a synthesis gas originating from a biomass-gasification process, the system comprising:
a stripping column;
a first quencher stage for quenching the synthesis gas at a first temperature and a first pressure resulting in a quenched synthesis gas;
a second quencher stage coupled to said first quencher stage for quenching the quenched synthesis gas at a second temperature and a second pressure, with the second temperature being lower than the first temperature resulting in a twice-quenched synthesis gas;
an oil scrubber, disposed downstream of said second quencher stage for scrubbing the twice-quenched synthesis gas resulting in a quenched and scrubbed synthesis gas, with a loaded scrubbing oil taken from said oil scrubber being thermally regenerated in at least one of said stripping column or by means of stripping gas and then recycled into said oil scrubber in a cooled state;
an adsorber stage, disposed downstream of said oil scrubber, for purifying the quenched and scrubbed synthesis gas using a catalyst-doped/activator-doped adsorbens resulting in a purified synthesis gas; and
a feeder disposed downstream from said adsorber stage for feeding the purified synthesis gas into a refining process.

24. The system according to claim 23, wherein a suitable temperature in said oil scrubber is within a range of −20 to 30° C.

25. The system according to claim 23, wherein the stripping gas originates from a refining process.

26. The system according to claim 23, wherein the loaded scrubbing oil removed from an oil-scrubbing process has fresh scrubbing oil added to it before it enters an oil stripper.

27. The system according to claim 23, further comprising:
a hydrogen-desulfurization catalysis (HDS) stage; and
a chemisorber, the purified synthesis gas being fed, before being fed to the refining process, to said HDS stage while being heated and then to said chemisorber while being cooled.

28. The system according to claim 27, wherein at least one of said adsorber stage or said chemisorber is embodied as being redundant.

29. The system according to claim 23, wherein a part of the loaded scrubbing oil that has been removed from said oil scrubber can be fed to at least one of a first or second quenching operation.

30. The system according to claim 25, wherein the stripping gas originates is a CO₂-rich gas from CO₂ separating.
